(19) United States
(12) Patent Application Publication
(10) Pub. No.: US 2011/0178897 A1
(43) Pub. Date: Jul. 21, 2011

(54) SYSTEMS AND METHODS FOR PROCESSING INCOMPLETE TRANSACTIONS OVER A NETWORK

(75) Inventors: Girish Balasubramanian, Fremont, CA (US); Jonathan Douglas Mann, Phoenix, AZ (US); Tejas Arvindbhai Kotecha, Milpitas, CA (US); Mark J. Boyd, Mountain View, CA (US)

(73) Assignee: EBAY INC., San Jose, CA (US)

(21) Appl. No.: 12/690,748

(22) Filed: Jan. 20, 2010

(51) Int. Cl. G06Q 30/00; G06Q 10/00; G06Q 20/00; G06F 15/16; G06F 3/01

(52) U.S. Cl. 705/27.1; 705/30; 705/34; 709/203; 715/760; 709/206; 709/201

(57) ABSTRACT

In accordance with one or more embodiments of the present disclosure, a system and method for facilitating electronic commerce over a network includes communicating with a user via a user device and a merchant via a merchant device over the network, storing an incomplete purchase transaction between the user and the merchant, generating a portable checkout link to the incomplete purchase transaction, providing the portable checkout link to the user over the network, allowing the user to select the incomplete purchase transaction for processing, and processing the incomplete purchase transaction upon user selection. The system and method may include notifying the user of the incomplete purchase transaction over the network.

### BACKGROUND

1. Technical Field

The present invention generally relates to facilitating electronic commerce over a network and, more particularly, to processing incomplete transactions over a network.

2. Related Art

In online financial transactions, users search for and purchase products and services through electronic communications with online merchants over electronic networks, such as the Internet. During the course of these purchase transactions, users may provide payment to a transaction service provider in various ways including, for example, credit cards, electronic fund transfers, and other payment techniques offered by the service providers.

Typically, when shopping at a particular website, users select items to purchase by clicking on a link for a specific item. The selected items are placed on reserve in some type of virtual shopping cart. When done shopping, the user is directed to checkout and provide some form of payment for the selected items.

At this point in the process, the user may withdraw from purchase or abandon the checkout prior to payment. When this occurs, the shopping cart and any reserved items may be deleted because the user failed to complete the purchase transaction. As such, this usually results in lost revenue for the online merchant and the payment service provider.

Thus, there currently exists a need to improve the process of handling shopping carts and reserved items in online purchase transactions.

### SUMMARY

Embodiments of the present disclosure provide systems and methods for facilitating electronic commerce including processing incomplete transactions over a network. In one embodiment, the system and method includes communicating with a user via a user device and a merchant via a merchant device over the network, storing an incomplete purchase transaction between the user and the merchant, generating a portable checkout link to the incomplete purchase transaction, providing the portable checkout link to the user over the network, allowing the user to select the incomplete purchase transaction for processing, and processing the incomplete purchase transaction upon user selection.

In various implementations, the system and method may include notifying the user of the incomplete purchase transaction over the network. For example, notifying the user may include sending a notification to the user over the network including at least one of an email, an alert, a text message, and a voice message. In another example, notifying the user may include providing a list of one or more incomplete purchase transactions to the user over the network, wherein each incomplete purchase transaction in the list includes a corresponding portable checkout link associated therewith.

In one implementation, the system and method may include determining whether the user selects at least one incomplete purchase transactions from the list for processing. The determination may be based on user selection of the portable checkout link related to the selected incomplete purchase transaction. The incomplete purchase transaction may be stored as part of an account related to the user. The account related to the user may include information related to the user including identification information. The system and method may include storing information related to a completed purchase transaction after processing the user selected incomplete purchase transaction between the user and the merchant.

These and other aspects of the present disclosure will be more readily apparent from the detailed description of the embodiments set forth below taken in conjunction with the accompanying drawings.

### BRIEF DESCRIPTION OF THE DRAWINGS

FIG. 1 shows a block diagram of a system adapted to facilitate electronic commerce over a network, in accordance with embodiments of the present disclosure.

FIGS. 2A-2C show various methods for facilitating electronic commerce over a network, in accordance with embodiments of the present disclosure.

FIG. 3A shows an email notification, in accordance with embodiments of the present disclosure.

FIG. 3B shows an alert notification, in accordance with embodiments of the present disclosure.

FIG. 3C shows a user transaction history, in accordance with embodiments of the present disclosure.

FIG. 3D shows a shared email notification, in accordance with embodiments of the present disclosure.

FIG. 4 is a block diagram of a computer system suitable for implementing one or more embodiments of the present disclosure.

Embodiments of the invention and their advantages are best understood by referring to the detailed description that follows. It should be appreciated that like reference numerals are used to identify like elements illustrated in one or more of the figures, wherein showings therein are for purposes of illustrating embodiments of the invention and not for purposes of limiting the same.

### DETAILED DESCRIPTION

Embodiments of the present disclosure provide systems and methods for facilitating electronic commerce including processing incomplete transactions over a network. For example, a user or buyer may fail to complete or abandon a purchase transaction during checkout processing. In this instance, a service provider capable of processing purchase transactions is adapted to notify and/or message the user or buyer to complete incomplete or abandoned purchase transactions, and with user permission, the service provider is adapted to process incomplete or abandoned transactions selected by the user for processing. In another example, the user or buyer may be notified via periodic message alerts (e.g., email, text, voice, etc.) of purchase transactions in progress and/or alerts in account overview pages when logged in to the service provider. These and other aspects of the present disclosure are described in greater detail herein.

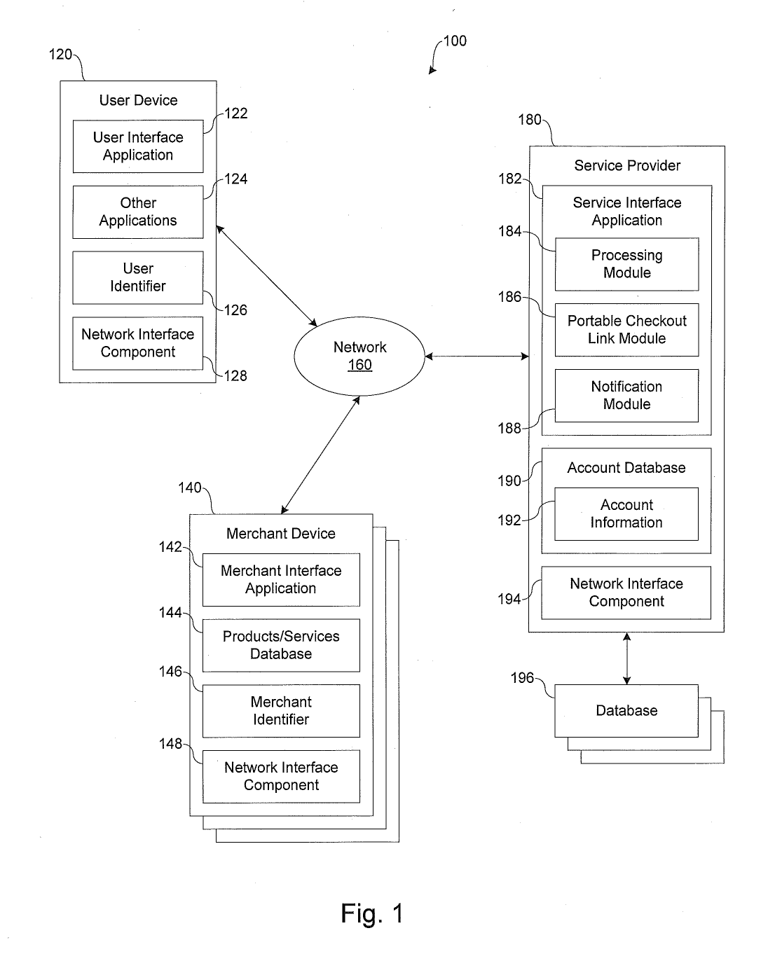

FIG. 1 shows one embodiment of a system 100 for facilitating electronic commerce including processing incomplete transactions, over a network 160, such as the Internet and/or a mobile communication network. As shown in FIG. 1, the system 100 includes a user device 120 (e.g., a client or customer device) adapted to interface with one or more merchant devices 140 (e.g., business entities proffering items, products, and/or services for purchase), and a service provider 160 (e.g., a network based transaction service provider, such as a payment and settlement transaction provider) over the network 160.

The network 160, in one embodiment, may be implemented as a single network or a combination of multiple networks. For example, the network 160 may include a wireless telecommunications network (e.g., cellular telephone network) adapted for communication with one or more other communication networks, such as the Internet. In other examples, the network 160 may include the Internet, one or more intranets, landline networks, wireless networks, and/or one or more other appropriate types of communication networks. As such, in various implementations, the user device 120, the one or more merchant devices 140, and the service provider 180 may be associated with a particular link (e.g., a link, such as a URL (Uniform Resource Locator) to an IP (Internet Protocol) address).

The user device 120, in various embodiments, may be implemented using any appropriate combination of hardware and/or software configured for wired and/or wireless communication over the network 160. In one embodiment, the user device 120 may be implemented as a mobile communication device (e.g., wireless cellular phone) adapted for communication with the network 160. In other embodiments, the user device 120 may be implemented as a personal computer (PC), a personal digital assistant (PDA), a notebook computer, and/or various other generally known types of wired and/or wireless computing devices for communication with the network 160. It should be appreciated that the user device 120 may be referred to as a client device or a customer device without departing from the scope of the present disclosure.

The user device 120, in one embodiment, includes a user interface application 122, which may be utilized by a user to conduct network based financial transactions (e.g., remote network based electronic commerce) with the one or more merchant devices 140 and/or the service provider 180 over the network 160. In various implementations, the user interface application 122 may be implemented as a network commerce application and/or a mobile commerce application to initiate, track, manage, and store data and information related to remote network based electronic commerce for viewing, searching, and/or purchasing items, products, and/or services over the network 160. In one aspect, the user device 120 may be linked to an account with the service provider 160 for direct and/or automatic settlement of purchase requests between a user and the one or more merchant devices 140 via the user interface application 122.

In one embodiment, the user interface application 122 comprises a software program, such as a graphical user interface (GUI), executable by a processor that is configured to interface and communicate with the one or more merchant devices 140 and/or the service provider 180 via the network 160. In one implementation, the user interface application 122 comprises a browser module adapted to provide a network interface to browse information available over the network 160. For example, the user interface application 122 may be implemented, in part, as a web browser to view and search information available over the network 160. In another example, the user is able to access merchant websites of the one or more merchant devices 140 over the network 160 to view, search, and select items, products, and/or services for purchase, and the user is able to purchase selected items, products, and/or services from the one or more merchant devices 140 via the service provider 180. As such, the user may conduct network based financial transactions (e.g., electronic commerce) with the one or more merchant devices 140 via the service provider 180.

In one embodiment, upon user instruction, the user interface application 122 may be installed and/or run on the user device 120. The user may run the user interface application 122 on the user device 120 to access the service provider 180 via the network 160. In one aspect, upon installation and/or execution of the user interface application 122, the user may be prompted to establish a user account for login with the service provider 180, wherein the user may use the user interface application 122 and the user device 120 to access the service provider 180 via the network 160. When establishing a user account, the user may be asked to provide personal information, such as name, address, phone number, etc., and financial information, such as banking information, credit card information, etc. In another aspect, referring to FIG. 1, information related to the user may be packaged as a user identifier 126, which is described in greater detail herein.

The user device 120, in various embodiments, may include other applications 124 as may be desired in one or more embodiments of the present disclosure to provide additional features available to the user. In various examples, such other applications 124 may include security applications for implementing user-side security features, programmatic client applications for interfacing with appropriate application programming interfaces (APIs) over the network 160, and/or various other types of generally known programs and/or software applications. In various other examples, other applications 124 may interface with the user interface application 122 for improved efficiency and convenience. In one example, files, data, and/or information may be imported from various types of accounting software (e.g., a spreadsheet application) directly into the user interface application 122 for improved tracking of payments and settlements related to purchases via the network 160. Accordingly, it should be appreciated that the user interface application 122 and each of the other applications 124 are adapted to make API calls over the network 160.

The user device 120, in various embodiments, may include the user identifier 126, which may be implemented as operating system registry entries, cookies associated with the user interface application 122, identifiers associated with hardware of the user device 120, and/or various other appropriate identifiers. The user identifier 126 may include one or more attributes related to the user, such as personal information related to the user (e.g., one or more user names, passwords, photograph images, biometric ids, addresses, phone numbers, etc.) and banking information (e.g., one or more banking institutions, credit card issuers, user account numbers, security data and information, etc.). In various aspects, the user identifier 126 may be passed with user transaction requests to the service provider 180 via the network 160, and the user identifier 126 may be utilized by the service provider 180 to associate the user with a particular user account maintained by the service provider 180.

The user device 120, in one embodiment, may include a network interface component (NIC) 128 adapted for communication with the network 160. In various implementations, the network interface component 128 may comprise a wireless communication component, such as a mobile cellular component, a wireless broadband component, a wireless satellite component, or various other types of wireless communication components including radio frequency (RF), microwave frequency (MWF), and/or infrared frequency (IRF) components adapted for communication with the network 160. In various other implementations, the network interface component 128 may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

The one or more merchant devices 140, in one embodiment, may be implemented using any appropriate combination of hardware and/or software configured for wired and/or wireless communication over the network 160. In various implementations, the merchant devices 140 may be implemented as a network server, a personal computer (PC), a personal digital assistant (PDA), a notebook computer, and/or various other generally known types of wired and/or wireless computing devices for communication with the network 160. In another implementation, the merchant device 140 may be implemented as a mobile device (e.g., a wireless cellular phone) adapted for communication with the network 160.

In another embodiment, the one or more merchant devices 140 may be maintained as one or more network servers by one or more business entities (e.g., merchant sites, resource information sites, utility sites, real estate management sites, social networking sites, etc.) offering various items, products, and/or services for purchase and payment, which may need registration of user identity information as part of offering the items, products, and/or services to one or more users over the network 160. Accordingly, each of the one or more merchant devices 140 may comprise at least one network based server in communication with the network 160 having a merchant interface application 142 and a products/services database 144 for presenting and identifying one or more available items, products, and/or services for purchase via the network 160, which may be made available to the user device 120 for viewing and purchase by the user. In one aspect, each of the network based merchant servers may be accessible via a mobile communication device (e.g., wireless cellular phone) for management purposes. For example, each merchant entity may remotely access and interact with their own network based merchant server via a mobile communication device for management purposes.

In one embodiment, each of the merchant devices 140 includes the merchant interface application 142, which may be utilized by the one or more merchant devices 140 to conduct network based financial transactions (e.g., remote network commerce, such as shopping, purchasing, bidding, etc.) with one or more users via one or more user devices 120 and/or the service provider 180 over the network 160. For example, the merchant interface application 142 may be implemented as an electronic commerce application to initiate, track, manage, and store data and information related to remote network based commerce for the viewing, searching, and purchasing of items, products, and/or services over the network 160. In one aspect, each merchant device 140 may be linked to an account with the service provider 160 for direct and/or automatic settlement of purchase requests between each merchant 140 and one or more users via the merchant interface application 142.

In one implementation, the merchant interface application 142 comprises a software program, such as a GUI, executable by a processor configured to interface and communicate with one or more users via one or more user devices 120 and/or the service provider 180 via the network 160. In another implementation, merchant interface application 142 comprises a network interface module that makes information available to the user device 120 over the network 160. For example, the merchant interface application 142 may be implemented, in part, as a website manager to provide, list, and present information to the user device 120 via the network 160. In another example, each merchant 140 is capable of providing one or more network based merchant websites to allow viewing, searching, and selecting of items, products, and/or services for purchase by the user via the user device 120, and the user is able to purchase items, products, and/or services from the one or more merchant devices 140 via the merchant websites and the service provider 180. As such, each of the merchant devices 140 may conduct financial transactions with the user via the merchant interface application 142 and the service provider 180.

In various implementations, the merchant interface application 142 may include a marketplace application, which may be configured to provide transaction information related to the products and/or services database 144 to the user interface application 122 of the user device 120 via the network 160. For example, the user may interact with the merchant 140 via the marketplace application through the user interface application 122 over the network 160 to search and view various items, products, and/or services available for purchase from the products/services database 144. In one implementation, the marketplace application may include a checkout module configured to facilitate online financial transactions by the user of items, products, and/or services identified by each merchant server 140 for purchase, and the checkout module may be configured to accept payment from the user over the network 160 and process the payment via interaction with the service provider 180.

In one implementation, upon merchant instruction, the merchant interface application 142 may be installed and/or run on each merchant device 140. Each merchant may run the merchant interface application 142 on their merchant device 140 to access service provider 180 via the network 160. In one aspect, upon installation and/or execution of the merchant interface application 142, each merchant may be prompted to establish a merchant account for login with the service provider 180, wherein each merchant may use merchant interface application 142 and merchant device 140 to access the service provider 180 via the network 160. In one aspect, when establishing a merchant account, each merchant may be asked to provide business information, such as business name, address, phone number, etc., and financial information, such as banking information, credit card information, etc. In another aspect, information related to the merchant may be packaged as a merchant identifier 146, which is described in greater detail herein.

In various implementations, the merchant interface application 142 may include one or more other applications as may be desired to provide additional features available to the merchant. In various examples, such other applications may include security applications for implementing user-side security features, programmatic applications for interfacing with appropriate application programming interfaces (APIs) over the network 160, and/or various other types of generally known programs and/or software applications. In various other examples, files, data, and/or information may be imported from various types of accounting software (e.g., a spreadsheet application) directly into the merchant interface application 142 for improved tracking of payments and settlements related to electronic commerce via the network 160. As such, it should be appreciated that merchant interface application 142 and any other application may be adapted to make API calls over the network 160.

Each of the merchant devices 140, in various embodiments, may include at least one merchant identifier 146, which may be included as part of the one or more items, products, and/or services made available for purchase so that, e.g., particular items, products, and/or services are associated with particular merchant devices 140. In one implementation, the merchant identifier 146 may include one or more attributes and/or parameters related to the merchant, such as business and/or banking information. For example, the merchant identifier 146 may be passed from each particular merchant 140 to the service provider 180 when the user selects an item, product, and/or service for holding, monitoring, and/or purchasing from each particular merchant 140. In one aspect, the merchant identifier 146 may be used by the service provider 180 to associate particular items, products, and/or services selected for purchase with a particular merchant account maintained by the service provider 180. In another aspect, the user may conduct financial transactions (e.g., selection, monitoring, purchasing, and/or providing payment for items, products, and/or services) with each merchant server 140 via the service provider 180 over the network 160.

In various embodiments, each of the one or more business entities having a related merchant server 140 may need to establish at least one merchant account with the service provider 180. When establishing a merchant account, each of the one or more business entities may need to provide business information, such as owner name, owner address, social security number, date of birth, phone number, email address, etc., and financial information, such as banking information, merchant account information, credit card information, payment processing information, etc.

In one embodiment, each merchant device 140 includes at least one network interface component (NIC) 148 adapted for communication with the network 160. For example, in various implementations, the network interface component 148 may comprise a wireless communication component, such as a mobile cellular component, a wireless broadband component, a wireless satellite component, or various other types of wireless communication components including radio frequency (RF), microwave frequency (MWF), and/or infrared frequency (IRF) components adapted for communication with the network 160. In various other implementations, the network interface component 148 may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

The service provider 180, in one embodiment, may be maintained by a network based transaction processing entity, which may provide processing for network based transactions including online information and/or financial transactions on behalf of the user via the user device 120 and/or each merchant device 140. As shown in FIG. 1, the service provider 180 includes a service interface application 182, which may be adapted to interact with the user device 120 and/or each merchant 140 over the network 160 to facilitate electronic commerce including processing incomplete transactions. In one example, a financial transaction may include the selection, purchase, and/or payment of items, products, and/or services by the user via the user device 120 from one or more merchant devices 140. In one embodiment, the service provider 180 may be provided by network based transaction processing entity, such as PayPal, Inc. and/or eBay of San Jose, Calif., USA.

The service interface application 182, in one embodiment, is adapted to utilize a processing module 184 to process purchases and/or payments for financial transactions between the user device 120 and each of the merchant devices 140. In one implementation, the processing module 184 is adapted to resolve financial transactions through validation, delivery, and settlement. For example, the service interface application 182 in conjunction with the processing module 184 is adapted to settle indebtedness on behalf of a user between the user device 120 and each of the merchant devices 140, wherein accounts may be directly and/or automatically debited and/or credited, respectively, of monetary funds in a manner as accepted by the banking industry.

The service interface application 182, in one embodiment, is adapted to utilize a portable checkout link module 186 adapted to provide user selectable links to incomplete and/or abandoned transactions. In one implementation, a portable checkout link (PCL) comprises a service provider checkout of a specific, loaded shopping cart having a state that may be frozen, saved, and/or accessed using a link, such as a URL link. In one aspect, the shopping cart may be associated with a specific merchant 140 and include a defined set of SKUs, SKU quantities, and SKU prices. In another aspect, a PCL may refer to an incomplete and/or abandoned checkout. In still another aspect, the PCL may reference a completed checkout or purchase transaction.

In one implementation, selecting (e.g., clicking on) a PCL may cause the shopping cart associated with the PCL to be regenerated similar to its original state but include various information related to inventory availability and price updates as provided by the merchant that generated the shopping cart. The PCL may be given an expiration date. If the PCL has not expired, the user may be directed to a checkout login page provided by the service provider 180. The user may log in to the service provider 180 to review one or more checkout pages, incomplete transactions, and/or abandoned transactions. If the PCL has expired, the user may be directed to a checkout login page provided by the merchant 140.

In one implementation, a unique URL with a token (i.e., PCL) may be generated when a user checks out from a merchant site to pay with the service provider 180. In one aspect, the unique URL or PCL may be used once and only once to checkout. The PCL may be valid for any amount of time (e.g., up to 72 hours), and the expiration parameter may be configurable by the merchant 140. As such, the expiration time for the PCL may be set by the merchant 140 to any desirable amount of time. The expired PCL may be re-validated (i.e., given a new validation time) by providing an API call to the merchant 140, which may lengthen or shorten the expiration life of the PCL.

In one implementation, the PCL directs the user to a portable shopping cart or a persistent shopping cart, wherein the user may return to the portable shopping cart or the persistent shopping cart at another time to proceed or complete a checkout or purchase transaction. In one aspect, the user may have withdrawn or abandoned the checkout or purchase transaction prior to completion or payment for selected items, products, and/or services. As such, the PCL module 186 provides a mechanism for the user to return and access a previously abandoned or incomplete purchase transaction by selecting the PCL from some form of notification, such as email or login alert, and then proceed with checkout from where the user previously left-off, withdrew, abandoned, or failed to complete the checkout.

In one aspect, a portable shopping cart refers to a mechanism where PCLs are passed between users as a batch, which may be referred to as a portable watchlist. In another aspect, a persistent shopping cart refers to a mechanism where a user having selections in a shopping cart with a first merchant may end the shopping session, and when starting another session with another merchant, the shopping cart may persist. As such, embodiments of the present disclose two separable aspects: portability and persistence.

In one implementation, the PCL module 186 may be adapted to coordinate with a notification module 188 to alert the user when the merchant 140 is about to run out of stock for the one or more items in the shopping cart or checkout referenced by the PCL. The user may be alerted when the price for the items in the shopping cart or checkout change, such as a price reduction. The user may be alerted if the merchant 140 provides a discount or coupon to complete the checkout.

In another implementation, the PCL module 186 may be adapted to share, broadcast, and/or publish PCLs to other users on the network 160. For example, if the PCL appears to have considerable value, the user may complete the purchase transaction and notify (e.g., email, tweet, text, voice message, etc.) other users about the items with a PCL to a similar purchase transaction. In another example, the user may add the PCL to a social networking site (e.g., twitter, facebook, myspace, etc.). As such, other users (e.g., friends, relatives, etc.) receiving the PCL may select or click on the PCL to view and purchase the items linked to the PCL (e.g., the user's purchases).

In another example, the user (e.g., an expert, writer, guru, etc.) may write an article about a particular item and create a PCL with a pre-fabricated shopping cart having the particular item ready to be checked out by other users. In another example, the user may create an item registry (e.g., a gift registry, wedding registry, etc.) having a plurality of PCLs that reference items from a plurality of different merchants 140. Once an item is selected, the item registry may be adapted to create a PCL with a pre-fabricated shopping cart having the selected item ready to be checked out by the selecting user. As such, in one aspect, the service provider 180 may be adapted to process referral purchase transactions via published PCLs and further generate affiliate fees or lead generation fees to increase revenue.

In another implementation, the user may create a pre-authorization for shared PCLs, wherein review of the shopping cart or checkout may be shared before the completion of purchase transactions with at least one other person, such as a supervisor, co-worker, other employee, subordinate, etc. For example, in a business case of a pre-screened shopping cart, an employee or subcontractor may select a list of materials and send the PCL linked to the list to a supervisor for approval. In another example, the supervisor may pre-approve items, categories, and merchants for payment from an account to a particular amount. In this case, the supervisor may send a pre-approved shopping cart having pre-approved PCLs to the employee, agent, or subcontractor to exercise further discretion for purchases.

In another example, a PCL shopping cart may be shared before transactions with a plurality of other users for pre-transaction aggregated commitments. In one implementation, a pre-screened shopping cart or PCL may be sent to multiple contributors with a commitment to partially pay, such as a partial authorization code that commits partial payment conditional on the next one or more users adding the remainder of payment.

In another implementation, partial chain payments may be passed around (e.g., in chain or as a broadcast) until the full amount is reached, some time limit is triggered, and/or some other related event occurs. In one aspect, chain commitments may sum previous commitments, and broadcasted commitments may reference a central record.

In another implementation, commitments may be made up of a combination of percentages with actual payment calculated by the number of contributors. For example, the commitment may be initially established with 10 users to commit 10% by a certain time, which sums to 100% for 10 users. However, 20 users actually commit, and therefore, the percentage by each contributor is altered to 5%, which sums to 100% for 20 users. In one aspect, this may encourage other users to contribute to reduce the amount each contributor has to finally contribute. For example, a concert costing $50,000 with more than a 1000 contributors results in a dynamic price distribution of less than $50 per person.

In another implementation, the PCL module 186 may be adapted to protect the privacy of the user. For example, when a PCL is revived, the PCL module 186 may be adapted to create a shopping cart with item information but leave out personally identifiable information (PII) including shipping, billing, and financial information. In the gift registry use case, the user may be given a choice to publish PCLs with pre-filled information, such as shipping address. In another example, affiliate links and revenue share added parameters may be encoded in a user-specific or transaction-specific manner to avoid identifying the affiliate and/or information related to the affiliate.

The service interface application 182, in one embodiment, is adapted to utilize a notification module 188, which is adapted to notify users of incomplete and/or abandoned transactions. In one implementation, the service interface application 182 in combination with the notification module 188 is adapted to notify or alert the user of incomplete and/or abandoned transactions with notifications or alerts (e.g., email message, text message, voice message, etc.) having one or more selectable links (e.g., PCLs) to the incomplete and/or abandoned transactions. In another implementation, if the user selects or clicks on a PCL in the notification or alert, then the user may review the one or more incomplete and/or abandoned transactions and request processing of the incomplete and/or abandoned transactions by the processing module 184. In various aspects, it should be appreciated that incomplete transactions may be referred to as abandoned transactions or checkout abandonments without departing from the scope of the present disclosure.

The service application 182, in one embodiment, may be adapted to utilize a selection processing module to process and monitor user selection events during online shopping by the user via the user device 120. In one aspect, the selection processing module allows the service provider 180 to process and monitor user selections during online navigation and shopping events over the network 160. For example, the service provider 180 interfaces with the user device 120 via, e.g., a browser window to monitor the user and the user device 120 during navigation and shopping events on various merchant sites. The selection processing module may be used by the service provider 180 to monitor user selections of one or more items, products, and/or services.

The service provider 180, in one embodiment, may be configured to maintain one or more user accounts and merchant accounts in an account database 190, each of which may include account information 192 associated with one or more individual users and the one or more merchant devices 140. For example, account information 192 may include private financial information of the user and each merchant 140, such as one or more account numbers, passwords, credit card information, banking information, or other types of financial information, which may be used to facilitate online financial transactions between the user and the one or more merchant devices 140. In various implementations, the methods and systems described herein may be modified to accommodate additional users and/or additional merchants that may or may not be associated with at least one existing user account and/or merchant account, respectively.

In one implementation, the user and/or user device 120 may have identity attributes stored with the service provider 180 as the user identifier 126, and the user and/or user device 120 may have credentials to authenticate or verify identity with the service provider 180. In one aspect, user attributes may include personal information and banking information, as previously described. In other aspects, the user attributes may be passed to the service provider 180 as part of a login and/or transaction request, and the user attributes may be utilized by the service provider 180 to associate the user and/or the user device 120 with one or more particular user accounts in the account database 190 maintained by the service provider 180.

In another implementation, each of the merchants and/or merchant devices 140 may have identity attributes stored with the service provider 180 as merchant identifiers 146, and each of the merchant devices 140 may have credentials to authenticate or verify identity with the service provider 180. In one aspect, merchant attributes may include business information and banking information, as previously described. In other aspects, the merchant attributes may be passed to the service provider 180 as part of a login and/or transaction request, and the merchant attributes may be utilized by the service provider 180 to associate each of the merchant devices 140 with one or more merchant accounts in the account database 190 maintained by the service provider 180.

The service provider 180, in various embodiments, may include a network interface component (NIC) 194 adapted for communication with the network 160 and any network based communication devices including the network interface component 128 of the user device 120 and the network interface component 148 of each merchant 140. In various implementations, the network interface component 194 of the service provider 180 may include a wireless communication component, such as a wireless broadband component, a wireless satellite component, or various other types of wireless communication components including radio frequency (RF), microwave frequency (MWF), and/or infrared frequency (IRF) components adapted for communication with the network 160. In other various implementations, the network interface component 148 may be adapted to interface with a DSL (e.g., Digital Subscriber Line) modem, a PSTN (Public Switched Telephone Network) modem, an Ethernet device, and/or various other types of wired and/or wireless network communication devices adapted for communication with the network 160.

The service provider 180, in various embodiments, may include one or more databases 196 (e.g., internal and/or external databases) for storing and tracking information related to financial transactions between particular users, such as the user, the one or more merchant devices 140, and the service provider 180. In one implementation, the databases 196 may provide a historical survey of transactions between the user device 120, the one or more merchant devices 140, and the service provider 180. For example, the service interface application 182 may be adapted to monitor, track, log, and store transaction information related to network based electronic commerce between the user device 120, each merchant 140, and/or the service provider 180, and the stored transaction information is accessible from the databases 196 for analysis, maintenance, and settlement.

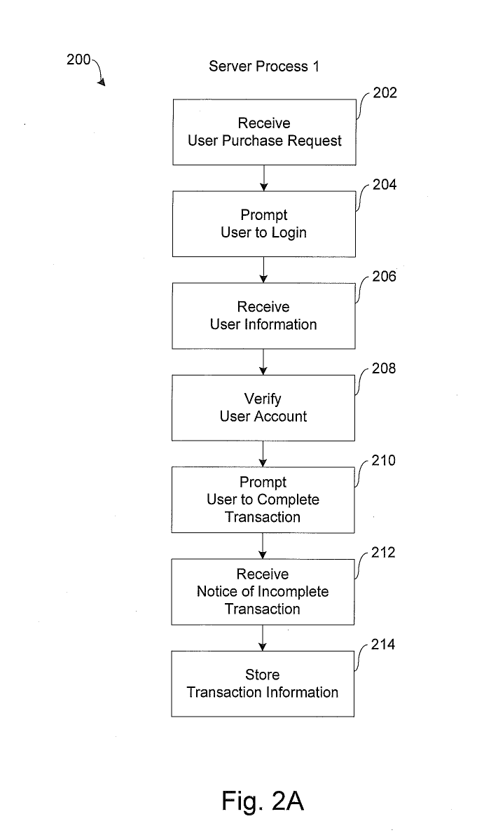

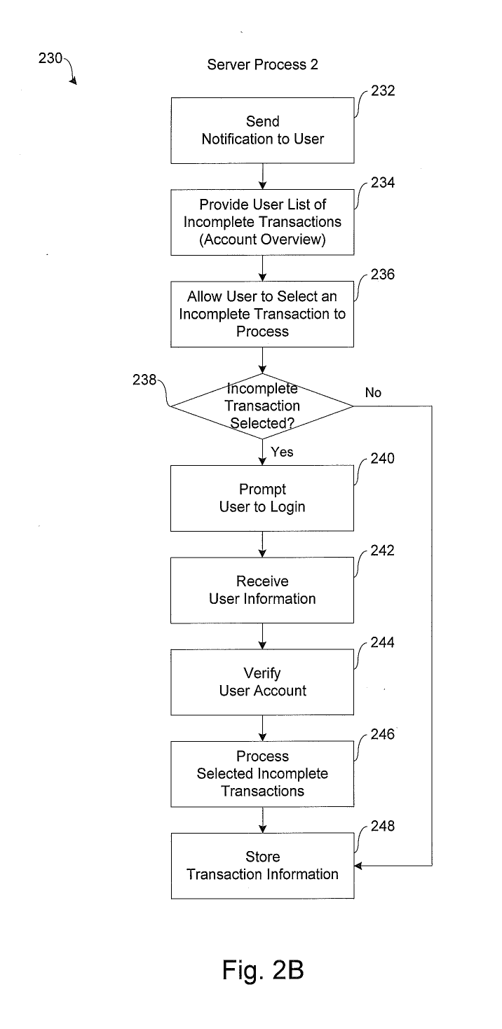

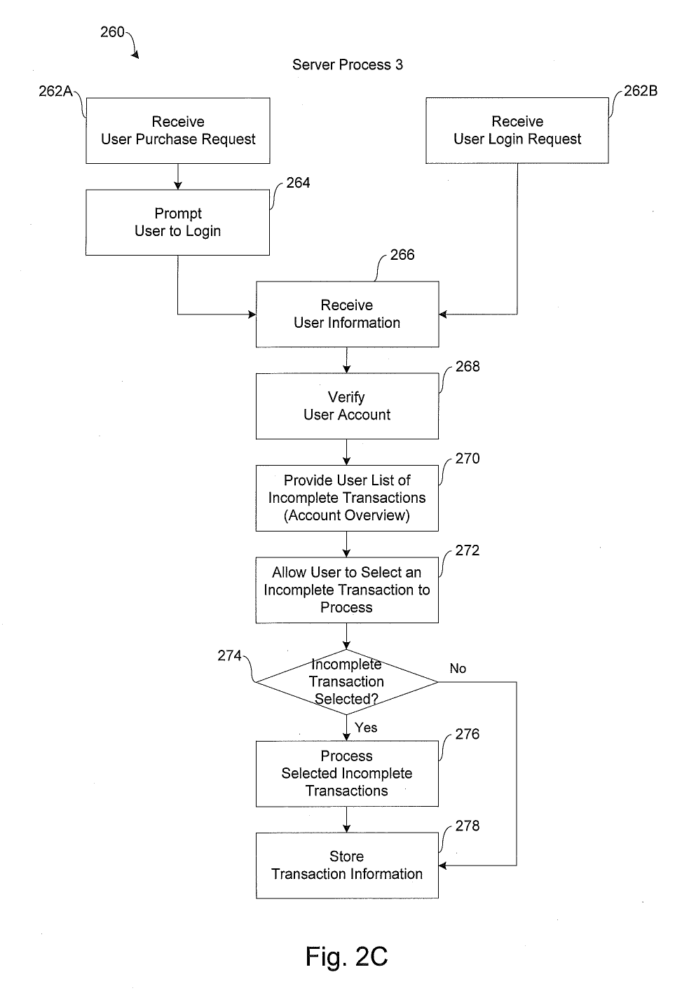

FIG. 2A shows one embodiment of a method 200 for facilitating electronic commerce including processing incomplete transactions over the network 160. It should be appreciated that, for purposes of explanation, the method 200 of FIG. 2A is described in reference to the system 100 of FIG. 1, but should not be limited thereto.

Referring to FIG. 2A, the service provider 180 is adapted to receive a purchase request from a user via the user device 120 over the network 160 (block 202). For example, a user or buyer may visit an online merchant website and navigate through the merchant's products and pages to select one or more items for purchase. The selected items are placed in a virtual shopping cart until checkout. When the user is done shopping, the user accesses a merchant webpage for viewing the selected items in the virtual shopping cart. At this merchant page, the user may decide to checkout (i.e., purchase) and select a link to the service provider 180 to request processing of the purchase transaction. Upon user selection, the service provider 180 receives a purchase request in reference to the shopping cart and the one or more items selected for purchase. In one aspect, the purchase request includes information related to the transaction including merchant name, merchant account, and one or more items selected for purchase including item description, price, weight, size, etc.

Next, the service provider 180 is adapted to prompt the user to login from the user device 120 over the network 160 (block 204). In one aspect, the user is logging in to the service provider 180 with an intention to checkout and purchase the items selected in the virtual shopping cart from the merchant as provided in the purchase request.

Next, the service provider 180 is adapted to receive user information, such as identity information, from the user via the user device 120 over the network 160 (block 206). In one aspect, user identity information may include attributes related to the user, such as personal information related to the user (e.g., usernames, passwords, photograph images, biometric ids, addresses, phone numbers, etc.) and banking information (e.g., banking institutions, credit card issuers, user account numbers, security information, etc.).

Next, the service provider 180 is adapted to verify a user account related to the user in the account database 190 based on user information passed from the user device 120 over the network 160 (block 208). In one implementation, the service provider device 180 processes a user login request by attempting to locate and access an account related to the user in the account database 190. If the user is determined to be an existing user by the service provider 180, then the service provider 180 is adapted to verify the user account and user identity information provider by user 102 in the user login request by comparing the received user information with account information 192 stored as part of the user account in the account database 190. In one aspect, the service provider 180 may determine if the user account is current and active. In some instances, user account information may need to be updated, and as such, the service provider device 180 may prompt the user 102 to update user account information 188 in the user account for the user.

It should be appreciated by those skilled in the art that the service provider 180 may cancel the user login request at any time during the process of method 200 if, for example, it is determined by the service provider 180 that the user enters wrong information or the user is trying to access an account with criminal intent.

Next, the service provider 180 is adapted to prompt the user to complete the requested transaction from the user device 120 over the network 160 (block 210). For example, in one implementation, the service provider 180 may prompt the user via the user device 120 to select a permission button to settle the debt with funds in the user account, which may be transferred from the user account to an account related to the merchant.

Next, the service provider 180 is adapted to receive a notice of incomplete transaction from the user device 120 over the network 160 (block 212). In one example, the incomplete transaction may include an abandoned transaction, wherein the user abandons the purchase transaction during checkout or prior to providing permission to settle the debt for the selected items in the purchase transaction.

Next, the service provider 180 is adapted to store transaction information related to the incomplete transaction (block 214). In one aspect, user information (e.g., attributes related to the user including user name and account number), merchant information (e.g., merchant name, merchant account, and the one or more items selected for purchase), and other transaction information related to the incomplete transaction may be stored as part of the user account in the account database 190 so that the service provider 180 may remind the user to complete the incomplete transaction at another time. These and other aspects of the present disclosure are described in greater detail herein.

FIG. 2B shows one embodiment of a method 230 for facilitating electronic commerce including processing incomplete transactions over the network 160. It should be appreciated that, for purposes of explanation, the method 230 of FIG. 2B is described in reference to the system 100 of FIG. 1, but should not be limited thereto.

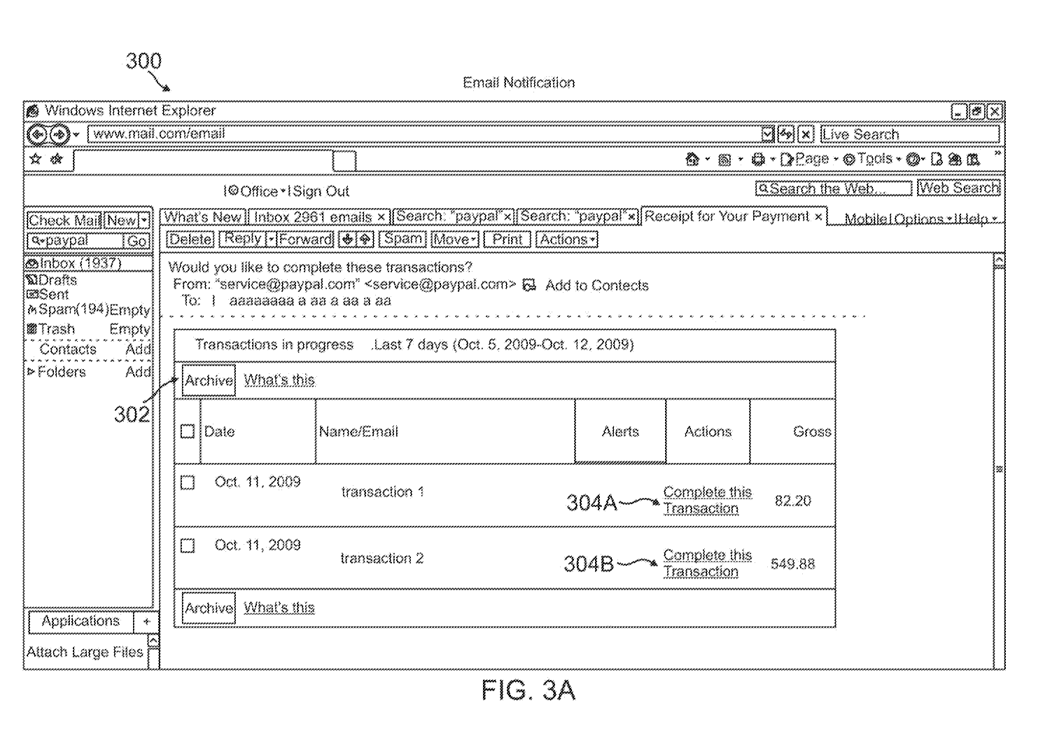

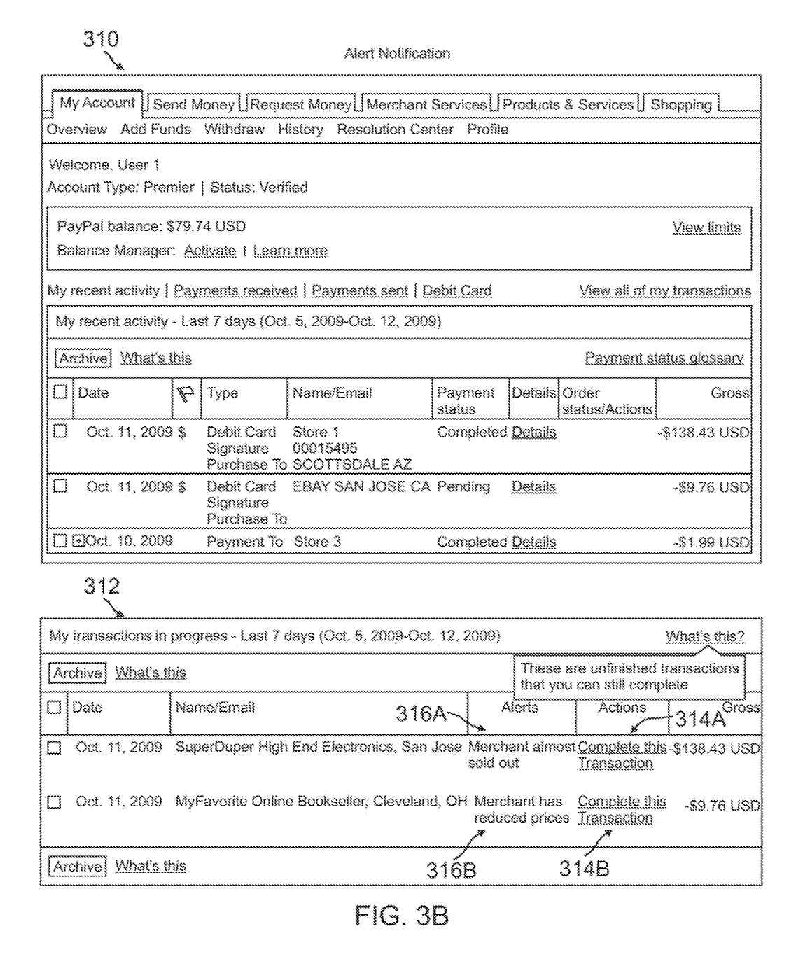

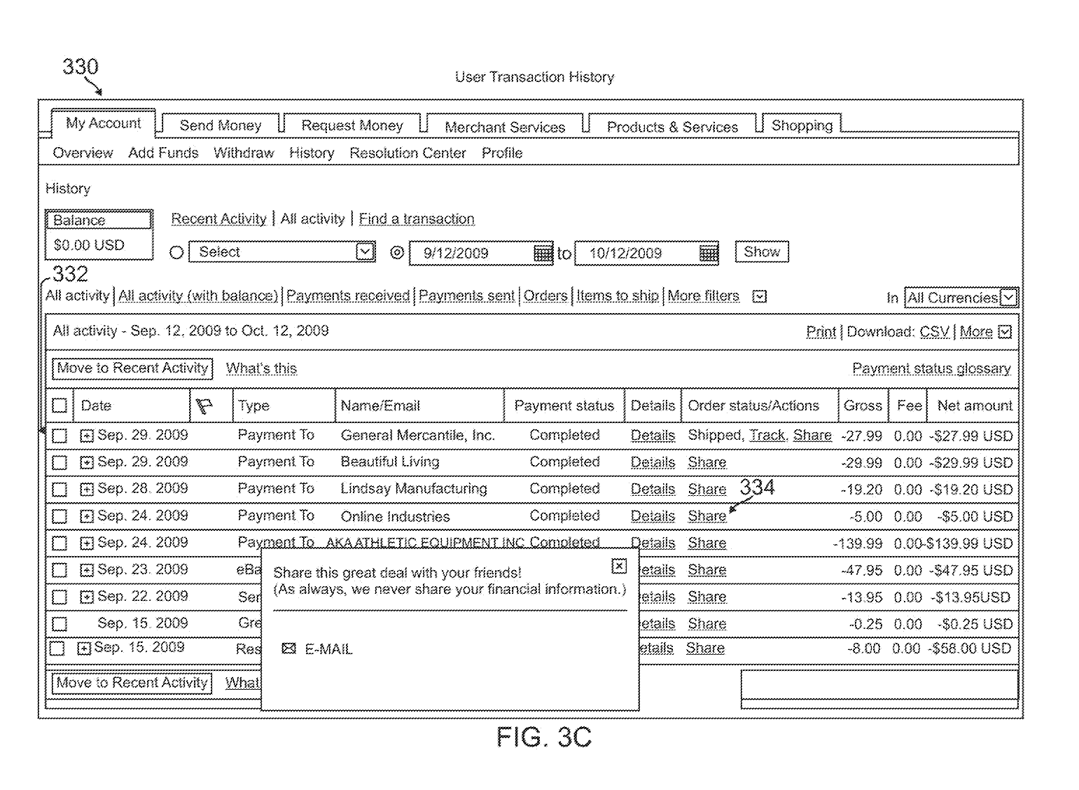

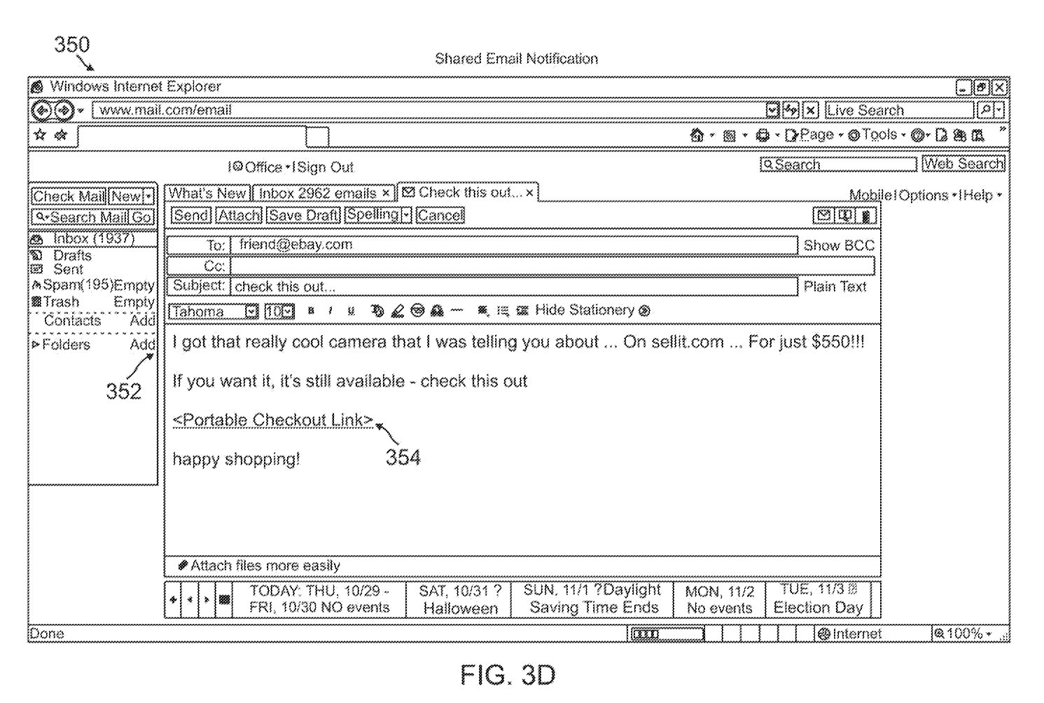

Referring to FIG. 2B, the service provider 180 is adapted to send notification of one or more incomplete transactions to a user via the user device 120 over the network 160 (block 232). In various implementations, the user may be notified via notification by email, alert, text message, voice message, postal mail, etc. For example, as shown in FIG. 3A, a user may be notified of one or more incomplete transactions via an email notification 300. In another example, as shown in FIG. 3B, a user may be notified of one or more incomplete transactions via an alert notification 310 having an account overview from a merchant 140.

Next, the service provider 180 is adapted to provide the user with a list of incomplete transactions via the user device 120 over the network 160 (block 234). In various examples, the list of incomplete transactions may comprise an interactive list having selectable links to incomplete transactions. For example, as shown in FIG. 3A, when a user is notified of one or more incomplete transactions via email notification 300, a list 302 of incomplete transactions may comprise an interactive list having one or more selectable links 304A, 304B related to one or more corresponding incomplete transactions. In another example, as shown in FIG. 3B, when a user is notified of one or more incomplete transactions via alert notification 310 from a merchant 140, alert notification 310 includes an account overview having a list 312 of incomplete transactions that may comprise an interactive list having one or more selectable links 314A, 314B related to one or more corresponding incomplete transactions.

In one embodiment, the service provider 180 is adapted to utilize portable checkout links (PCLs) to provide the user with the selectable links to corresponding incomplete and/or abandoned transactions. For example, the PCL is adapted to direct the user to a specific shopping cart having a state that may be frozen, saved, and/or accessed using a link, such as a URL link, and the shopping cart may be associated with a specific merchant 140.

In one implementation, selecting (e.g., clicking on) a PCL may cause the shopping cart associated with the PCL to be regenerated similar to its original state but include various information related to inventory availability and price updates as provided by the merchant that generated the shopping cart. As such, PCLs provide a mechanism for the user to return and access a previously abandoned or incomplete purchase transaction by selecting the PCL and then proceeding with checkout from where the user previously left-off, withdrew, abandoned, or failed to complete the checkout, which is described herein.

Next, the service provider 180 is adapted to allow the user to select one or more incomplete transactions from the list to process via the user device 120 over the network 160 (block 236). For instance, referring to FIGS. 3A, 3B, the user may review either notification 300, 310 and choose to complete an incomplete or abandoned transaction by selecting one or more of the selectable links 304A, 304B, 314A, 314B, respectively, related to one or more corresponding incomplete transactions. In one aspect, referring to FIG. 3B, a merchant 140 may provide the user the alert notification 310 to thereby allow the user to review and/or complete one or more incomplete or abandoned transactions. In this instance, the user may be redirected to the previously abandoned checkout page or shopping cart to review and/or complete the selected transaction. As shown in FIG. 3B, the merchant is adapted to provide the user with current availability status 316A, 316B, such as current inventory status, current price, etc., of one or more selected items for purchase in the shopping cart.

Next, the service provider 180 is adapted to determine whether the user selected one or more incomplete transactions to process from the user device 120 over the network 160 (block 238). If the service provider 180 determines that the user did not select at least one incomplete transaction to process (block 238), then the service provider 180 is adapted to store transaction information related to the incomplete transaction (block 248).

Otherwise, if the service provider 180 determines that the user selected at least one incomplete transaction to process (block 238), then the service provider 180 prompts the user to login from the user device 120 over the network 160 (block 240), receive user information, such as identity information, from the user via the user device 120 over the network 160 (block 242), and verify a user account related to the user in the account database 190 based on user information passed from the user device 120 over the network 160 (block 244).

Next, the service provider 180 is adapted to process incomplete transactions selected by the user from the user device 120 over the network 160 (block 246) and store transaction information related to the completion of transactions (block 248). In one aspect, information related to completed transactions may include information related to purchase transactions that were previously indicated as incomplete and/or abandoned transactions. Once selected for processing by the user and following processing by the service provider 180, the status of purchase transactions previously indicated as incomplete and/or abandoned transactions may be changed to reflect a revised status of completed transaction.

FIG. 2C shows one embodiment of a method 260 for facilitating electronic commerce including processing incomplete transactions over the network 160. It should be appreciated that, for purposes of explanation, the method 260 of FIG. 2C is described in reference to the system 100 of FIG. 1, but should not be limited thereto.

In one implementation, referring to FIG. 2C, the service provider 180 may be adapted to receive a purchase request from a user via the user device 120 over the network 160 (block 262A). Next, the service provider 180 is adapted to prompt the user to login from the user device 120 over the network 160 (block 264) and receive user information, such as identity information, from the user via the user device 120 over the network 160 (block 266).

In another implementation, referring to FIG. 2C, the service provider 180 may be adapted to receive a login request from a user via the user device 120 over the network 160 (block 262B) and receive user information, such as identity information, from the user via the user device 120 over the network 160 (block 266).

In either implementation, the service provider 180 is adapted to verify a user account related to the user in the account database 190 based on user information passed from the user device 120 over the network 160 (block 268).

Next, the service provider 180 is adapted to provide the user with a list of incomplete transactions via the user device 120 over the network 160 (block 270). In various examples, the list of incomplete transactions may comprise an interactive list having selectable links to incomplete transactions.

Next, the service provider 180 is adapted to allow the user to select one or more incomplete transactions from the list to process via the user device 120 over the network 160 (block 272). Next, the service provider 180 is adapted to determine whether the user selected one or more incomplete transactions to process from the user device 120 over the network 160 (block 274). If the service provider 180 determines that the user did not select at least one incomplete transaction to process (block 274), then the service provider 180 is adapted to store transaction information related to the incomplete transaction (block 278).

Otherwise, if the service provider 180 determines that the user selected at least one incomplete transaction to process (block 274), then the service provider 180 is adapted to process incomplete transactions selected by the user from the user device 120 over the network 160 (block 276). Next, the service provider 180 is adapted to store transaction information related to the completion of transactions (block 278).

FIG. 3C shows a graphic illustration of a user transaction history 330, in accordance with embodiments of the present disclosure. In one implementation, once logged in to the service provider 180, a user may access their user account in the account database 190 and review a list 332 of their transactional history of one or more previous purchases.

As shown in FIG. 3C, the user may share knowledge of particular transactions with other users, friends, relatives, etc. directly from their transaction history by way of selecting one or more of selectable ‘share’ links 334 corresponding to one or more previous purchase transactions. For example, by clicking on a ‘share’ link 334, the user enables selection of an option, wherein the ‘share’ link 334 may pre-fill information for the selected option and pass the information onto one or more other individuals (e.g., other users, friends, relatives, etc.). In one aspect, one or more of these particular transactions may be considered good deals or sales, and the user is allowed to pass information of these particular transactions to other individuals (e.g., other users, friends, relatives, etc.) over the network 160.

In one aspect, the ability to share information from particular purchase transactions may be referred to as social shopping via portable checkout links. For example, in reference to the concept of sharing shopping information, a user gains the ability to inform friends, family, and other users on the network 160 to purchase the same items at the same price form the same merchants via notifications and/or portable checkout links.

FIG. 3D shows a graphic illustration of an email notification 350 having user shared information 352 from the user transaction history 330 of FIG. 3C and a portable checkout link 354 associated with a particular transactional item related to the shared information 352, in accordance with embodiments of the present disclosure. In one implementation, the receiver of the email notification 350 may access, review, and/or purchase the same item as the user sending the email notification 350 via the portable checkout link 354, which may result in a new purchase transaction for a merchant 140 and/or service provider 180. As such, in one aspect, the email notification 350 allows a user to share information related to one or more purchase transactions with other individuals (e.g., other users, friends, relatives, etc.).

The systems and methods disclosed herein provide various advantages. For example, merchants may recover incomplete or abandoned shopping carts and purchase transactions, gain free or shared publicity, and attract new sales from referrals. Users, buyers, consumers, clients, etc. gain the convenience of completing a purchase transaction at another, more convenient time, which enables higher engagement, and users gain fulfillment from sharing good deals with others. Service providers may achieve increased revenues, more transaction completions, diversification of revenues including referral fees from merchants for new sales, ubiquity and publicity from portable checkout links being published on the network 160, and merchant goodwill, which may result in a preferred status for merchant checkouts.

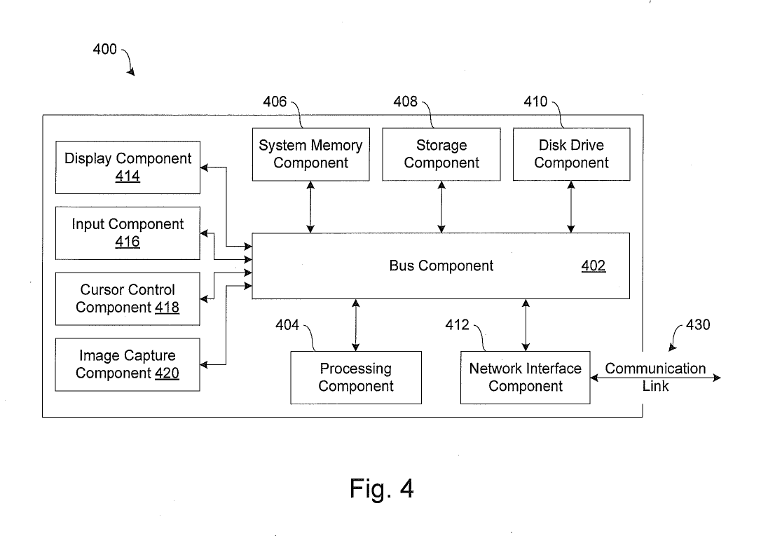

FIG. 4 is a block diagram of a computer system 400 suitable for implementing various embodiments of the present disclosure, including the user device 120, the merchant devices 140, and the service provider device 180. In various implementations, the user device 120 may comprise a network communication device (e.g., mobile cellular phone, laptop, personal computer, etc.) capable of communicating with the network 160, the merchant devices 140 may comprise a network computing device (e.g., a network server), and the service provider device 180 may comprise a network computing device (e.g., a network server). In other implementations, it should be appreciated that the merchant devices 140 and the service provider device 180 may comprise a network communication device (e.g., mobile cellular phone, laptop, personal computer, etc.) capable of communicating with the network 160, without departing from the scope of the present disclosure. Hence, it should be appreciated that each of the devices 120, 140, 180 may be implemented as the computer system 400 for communication with the network 160 in a manner as follows.

In accordance with various embodiments of the present disclosure, computer system 400, such as a mobile communication device and/or a network server, includes a bus 402 or other communication mechanism for communicating information, which interconnects subsystems and components, such as processing component 404 (e.g., processor, micro-controller, digital signal processor (DSP), etc.), system memory component 406 (e.g., RAM), static storage component 408 (e.g., ROM), disk drive component 410 (e.g., magnetic or optical), network interface component 412 (e.g., modem or Ethernet card), display component 414 (e.g., CRT or LCD), input component 416 (e.g., keyboard), cursor control component 418 (e.g., mouse or trackball), and image capture component 420 (e.g., analog or digital camera). In one implementation, disk drive component 410 may comprise a database having one or more disk drive components.

In accordance with embodiments of the present disclosure, computer system 400 performs specific operations by processor 404 executing one or more sequences of one or more instructions contained in system memory component 406. Such instructions may be read into system memory component 406 from another computer readable medium, such as static storage component 408 or disk drive component 410. In other embodiments, hard-wired circuitry may be used in place of or in combination with software instructions to implement the present disclosure.

Logic may be encoded in a computer readable medium, which may refer to any medium that participates in providing instructions to processor 404 for execution. Such a medium may take many forms, including but not limited to, non-volatile media and volatile media. In various implementations, non-volatile media includes optical or magnetic disks, such as disk drive component 410, and volatile media includes dynamic memory, such as system memory component 406. In one aspect, data and information related to execution instructions may be transmitted to computer system 400 via a transmission media, such as in the form of acoustic or light waves, including those generated during radio wave and infrared data communications. In various implementations, transmission media may include coaxial cables, copper wire, and fiber optics, including wires that comprise bus 402

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 430 (e.g., network 160 of FIG. 1, such as a LAN, WLAN, PTSN, and/or various other wired or wireless networks, including telecommunications, mobile, and cellular phone networks) may perform instruction sequences to practice the present disclosure in coordination with one another.

Computer system 400 may transmit and receive messages, data, information and instructions, including one or more programs (i.e., application code) through communication link 430 and communication interface 412. Received program code may be executed by processor 404 as received and/or stored in disk drive component 410 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for facilitating electronic commerce over a network, the method comprising:
communicating with a user via a user device and a merchant via a merchant device over the network;
storing an incomplete purchase transaction between the user and the merchant;
generating a portable checkout link to the incomplete purchase transaction;
providing the portable checkout link to the user over the network;
allowing the user to select the incomplete purchase transaction for processing; and
processing the incomplete purchase transaction upon user selection.

2. The method of claim 1, further comprising notifying the user of the incomplete purchase transaction over the network.

3. The method of claim 2, wherein notifying the user includes sending a notification to the user over the network including at least one of an email, an alert, a text message, and a voice message.

4. The method of claim 2, wherein notifying the user includes providing a list of one or more incomplete purchase transactions to the user over the network, and wherein each incomplete purchase transaction in the list includes a corresponding portable checkout link associated therewith.

5. The method of claim 4, further comprising determining whether the user selects at least one of the incomplete purchase transactions for processing from the list, wherein the determination is based on user selection of the portable checkout link related to the selected incomplete purchase transaction.

6. The method of claim 1, further comprising storing information related to a completed purchase transaction after processing the selected incomplete purchase transaction between the user and the merchant.

7. The method of claim 1, further comprising:
receiving a purchase request from the user via the user device over the network;
prompting the user to login over the network;
receiving user information including user identity information from the user via the user device over the network;
verifying the identity of the user based on the user information; and
verifying a user account related to the user.

8. The method of claim 1, further comprising:
receiving a login request from the user via the user device over the network; and
processing the login request by verifying the identity of the user and accessing an account related to the user based on user information passed with the login request.

9. The method of claim 1, wherein the incomplete purchase transaction is stored as part of an account related to the user, and the account related to the user includes information related to the user including identification information.

10. The method of claim 1, wherein the method is performed by a network server adapted to communicate with the user device and the merchant device over the network.

11. A system for facilitating electronic commerce over a network, the system comprising:
means for communicating with a user via a user device and a merchant via a merchant device over the network;
means for storing an incomplete purchase transaction between the user and the merchant;
means for generating a portable checkout link to the incomplete purchase transaction;
means for providing the portable checkout link to the user over the network;
means for allowing the user to select the incomplete purchase transaction for processing; and
means for processing the incomplete purchase transaction upon user selection.

12. The system of claim 11, further comprising means for notifying the user of the incomplete purchase transaction over the network.

13. The system of claim 12, wherein means for notifying the user includes means for sending a notification to the user over the network including at least one of an email, an alert, a text message, and a voice message.

14. The system of claim 12, wherein means for notifying the user includes means for providing a list of one or more incomplete purchase transactions to the user over the network, and wherein each incomplete purchase transaction in the list includes a corresponding portable checkout link associated therewith.

15. The system of claim 14, further comprising means for determining whether the user selects at least one of the incomplete purchase transactions for processing from the list, wherein the determination is based on user selection of the portable checkout link related to the selected incomplete purchase transaction.

16. The system of claim 11, further comprising means for storing information related to a completed purchase transaction after processing the selected incomplete purchase transaction between the user and the merchant.

17. The system of claim 11, further comprising:
means for receiving a purchase request from the user via the user device over the network;
means for prompting the user to login over the network;
means for receiving user information including user identity information from the user via the user device over the network;
means for verifying the identity of the user based on the user information; and
means for verifying a user account related to the user.

18. The system of claim 11, further comprising:
means for receiving a login request from the user via the user device over the network; and
means for processing the login request by verifying the identity of the user and accessing an account related to the user based on user information passed with the login request.

19. The system of claim 11, wherein the incomplete purchase transaction is stored as part of an account related to the user, and the account related to the user includes information related to the user including identification information.

20. The system of claim 11, comprising a network server adapted to communicate with the user device and the merchant device over the network.

21. A computer readable medium on which are stored computer readable instructions and when executed operable to:
communicate with a user via a user device and a merchant via a merchant device over the network;
store an incomplete purchase transaction between the user and the merchant;
generate a portable checkout link to the incomplete purchase transaction;
provide the portable checkout link to the user over the network;
allow the user to select the incomplete purchase transaction for processing; and
process the incomplete purchase transaction upon user selection.

22. The computer readable medium of claim 21, further operable to notify the user of the incomplete purchase transaction over the network, wherein notifying the user includes sending a notification to the user over the network including at least one of an email, an alert, a text message, and a voice message.

23. The computer readable medium of claim 21, further operable to notify the user of the incomplete purchase transaction over the network, wherein notifying the user includes providing a list of one or more incomplete purchase transactions to the user over the network, and wherein each incomplete purchase transaction in the list includes a corresponding portable checkout link associated therewith.

24. The computer readable medium of claim 21, further operable to determine whether the user selects at least one of the incomplete purchase transactions for processing from the list, wherein the determination is based on user selection of the portable checkout link related to the selected incomplete purchase transaction.

25. The computer readable medium of claim 21, further operable to store information related to a completed purchase transaction after processing the selected incomplete purchase transaction between the user and the merchant.
